(19) United States
(12) Patent Application Publication
(10) Pub. No.: US 2022/0143560 A1
(43) Pub. Date: May 12, 2022

(54) ISOPOROUS POLYMER MEMBRANES

(71) Applicant: King Abdullah University of Science and Technology, Thuwal (SA)

(72) Inventors: Suzana Pereira NUNES, Thuwal (SA); Ainur SABIROVA, Thuwal (SA)

(21) Appl. No.: 17/430,795

(22) PCT Filed: Feb. 12, 2020
(86) PCT No.: PCT/IB2020/051155

§ 371 Date: Aug. 13, 2021

Related U.S. Application Data
(60) Provisional application No. 62/804,880, filed on Feb. 13, 2019.
(60) Provisional application No. 62/900,778, filed on Sep. 16, 2019.

(51) Int. Cl. B01D 67/00; B01D 69/02; B01D 63/00

(52) U.S. Cl. CPC B01D 67/0034; B01D 67/0088; B01D 2325/08; B01D 63/005; B01D 2325/021; B01D 69/02

(57) ABSTRACT

Embodiments of the present disclosure describe an isoporous polymer membrane comprising a polymeric film having a plurality of isopores, wherein the isoporous polymer membrane is characterized in that it has one or more of the following features: a porosity of about 20% or greater, a plurality of isopores arranged in an ordered array, wherein the plurality of isopores extend from a first membrane surface to a second membrane surface along an axis perpendicular to the first and second membrane surfaces, a membrane size of about 45 cm² or greater, and a pore size of about 2 μm or less. Embodiments of the present disclosure also describe methods of fabricating the isoporous polymer membranes, applications using the isoporous polymer membranes, and the like.

### BACKGROUND

Membranes with ordered pores (isoporous) are used not only in water purification processes, but also in various biomedical and petrochemical applications including: separation of chemical/biological species, emulsification, targeted drug delivery, tissue engineering, blood filtration, etc. Conventional methods for fabricating isoporous membranes, some of which (but not all) are used currently in industry (for the above-mentioned applications), include the following: track-etched membranes, anodic aluminum oxide membranes, membranes produced by a combination of block copolymer self-assembly and phase inversion, and membranes fabricated by the breath method. Some of these methods require harsh solvents that are not environmentally friendly.

Track-etched membranes have been fabricated from dense films of polycarbonates and poly(ethylene terephthalate) to obtain isoporous membranes. In the production of track-etched membranes, polymeric films are exposed to a high-energy ion bombardment of fission fragments from radioactive decay with subsequent etching in alkaline solution. This high-energy bombardment precludes the formation of well-ordered symmetrical pores because pores formed by ion bombardment are randomly scattered and overlap with each other. Such membranes suffer from very low porosity and can only achieve porosities between 5-15%. The fabrication technique also requires a nuclear reactor.

Isoporous membranes can also be formed through electrolytic oxidation of aluminum to obtain anodic aluminum oxide membranes based on alumina, a ceramic. Such membranes can achieve a higher porosity than the track-etched membranes, but it has been shown that a significant disadvantage of anodic aluminum oxide membranes is that they are very fragile/brittle and very expensive to fabricate.

Another technique used to form isoporous membranes, which was invented by Applicants, is a combination of block copolymer self-assembly and phase inversion. The process of preparation according to this technique is very different from the others. It is a solution casting process that requires the use of block copolymers under tightly controlled conditions. While isoporous membranes can be achieved, the technique forms asymmetric membranes with an isoporous layer formed only in the top layer (e.g., top 400 nm) and a non-ordered porous sublayer formed beneath it. Accordingly, the pore size is not constant through the entire membrane from a top membrane surface through a bottom membrane surface.

Breath figures or the breath technique can be used to produce isoporous membranes using a three-dimensional ordered array of air bubbles in a polymer film. This technique uses spreading of a polymer solution in a rather apolar solvent and a moist gas stream is directed in a controlled manner over the solvent-containing polymer film. The pores are created through a combination of evaporation and condensation of water droplets on the surface of the polymer film. It is not possible to obtain pores with a sufficient small diameter and has no commercial applications.

### SUMMARY

In general, embodiments of the present disclosure describe isoporous polymer membranes, methods of fabricating isoporous polymer membranes, applications using the isoporous polymer membranes, and the like.

Embodiments of the present disclosure describe isoporous polymer membranes comprising a polymeric film having a plurality of isopores.

Embodiments of the present disclosure further describe isoporous polymer membranes comprising a polymeric film having a plurality of isopores, wherein the isoporous polymer membrane is characterized in that it has one or more of the following features:

(a) a porosity of about 20% or greater,

(b) a plurality of isopores arranged in an ordered array, wherein the plurality of isopores extend from a first membrane surface to a second membrane surface along an axis perpendicular to the first and second membrane surfaces,

(c) a membrane size of about 45 cm² or greater, and

(d) a pore size of about 2 μm or less.

Embodiments of the present disclosure further describe isoporous polymer membranes comprising a polymeric film having a porosity of about 20% or greater and a plurality of isopores arranged in an ordered array, wherein the plurality of isopores extend from a first membrane surface to a second membrane surface along an axis perpendicular to the first and second membrane surfaces. In some embodiments, the isoporous polymer membranes are further characterized in that the membrane size is about 45 cm² or greater. In some embodiments, the isoporous polymer membranes are further characterized in that the plurality of isopores have a pore size of about 2 μm or less.

Embodiments of the present disclosure further describe isoporous polymer membranes comprising a polymeric film having a porosity of about 20% or greater and a plurality of isopores, wherein the isoporous polymer membrane has a membrane size of about 45 cm² or greater. In some embodiments, the isoporous polymer membranes are further characterized in that the plurality of isopores is arranged in an ordered array, wherein the plurality of isopores extend from a first membrane surface to a second membrane surface along an axis perpendicular to the first and second membrane surfaces. In some embodiments, the isoporous polymer membranes are further characterized in that the plurality of isopores have a pore size of about 2 μm or less.

Embodiments of the present disclosure further describe isoporous polymer membranes comprising a polymeric film having a porosity of about 20% or greater and a plurality of isopores having a pore size of about 2 μm or less. In some embodiments, the isoporous polymer membranes are further characterized in that the plurality of isopores is arranged in an ordered array, wherein the plurality of isopores extend from a first membrane surface to a second membrane surface along an axis perpendicular to the first and second membrane surfaces. In some embodiments, the isoporous polymer membranes are further characterized in that the membrane size is about 45 cm² or greater.

Embodiments of the present disclosure further describe isoporous polymer membranes comprising a polymeric film having a plurality of isopores, wherein the plurality of isopores extend from a first membrane surface to a second membrane surface along an axis perpendicular to the first and second membrane surfaces, wherein the isoporous polymer membrane has a membrane size of about 45 cm² or greater. In some embodiments, the isoporous polymer membranes are further characterized in that the polymeric film has a porosity of about 20% or greater. In some embodiments, the isoporous polymer membranes are further characterized in that the plurality of isopores have a pore size of about 2 μm or less.

Embodiments of the present disclosure further describe isoporous polymer membranes comprising a polymeric film having a plurality of isopores, wherein the plurality of isopores have a pore size of about 2 μm or less, wherein the plurality of isopores extend from a first membrane surface to a second membrane surface along an axis perpendicular to the first and second membrane surfaces. In some embodiments, the isoporous polymer membranes are further characterized in that the polymeric film has a porosity of about 30% or greater. In some embodiments, the isoporous polymer membranes are further characterized in that the membrane size is about 45 cm² or greater.

Embodiments of the present disclosure further describe isoporous polymer membranes comprising a polymeric film having a plurality of isopores, wherein the plurality of isopores have a pore size of about 2 μm or less, wherein the isoporous polymer membrane has a membrane size of about 45 cm² or greater. In some embodiments, the isoporous polymer membranes are further characterized in that the polymeric film has a porosity of about 20% or greater. In some embodiments, the isoporous polymer membranes are further characterized in that the plurality of isopores is arranged in an ordered array, wherein the plurality of isopores extend from a first membrane surface to a second membrane surface along an axis perpendicular to the first and second membrane surfaces.

Embodiments of the present disclosure further describe methods of fabricating an isoporous polymer membrane comprising loading a substrate having at least a photoresist layer and a polymer layer into a photolithography system, exposing the photoresist layer of the substrate to ultraviolet through a photomask having a pattern, developing the exposed photoresist layer in a developing bath to transfer the pattern from the photomask to the photoresist layer, and etching the polymer material in areas not covered by the patterned photoresist layer to form an isoporous polymer membrane having high porosity and a periodically ordered array of isopores.

Embodiments of the present disclosure further describe methods of separating one or more chemical species comprising contacting any isoporous polymer membrane of the isoporous polymer membranes of the present disclosure with a fluid composition comprising one or more chemical species and separating at least one of the chemical species from the fluid composition.

Embodiments of the present disclosure further describe methods of separating one or more biological components comprising contacting any of the isoporous polymer membranes of the present disclosure with a fluid composition including one or more biological components and separating at least one of the biological components from the fluid. In some embodiments, the biological components include cells, organelles, and biomolecules.

Embodiments of the present disclosure further describe a device comprising a first compartment and a second compartment separated by any of the isoporous polymer membranes of the present disclosure. In some embodiments, the membrane functions as an extracellular matrix.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of fabricating an isoporous polymer membrane, according to one or more embodiments of the present disclosure.

FIG. 2 is a flowchart of a method of separating one or more chemical species, according to one or more embodiments of the present disclosure.

FIG. 3 is a flowchart of a method of separating one or more biological components, according to one or more embodiments of the present disclosure.

FIG. 4 is an image of a top surface of an isoporous polymer membrane with a pore size of 5 μm, according to one or more embodiments of the present disclosure.

FIG. 5 is an image of a top surface of an isoporous polymer membrane with a pore size of about 2 μm, according to one or more embodiments of the present disclosure.

FIG. 6 is an image of a top surface of an isoporous polymer membrane with a pore size of about 2 μm, wherein the isoporous polymer membrane has been transformed into an isoporous polymer membrane with a pore size of about 787 nm, according to one or more embodiments of the present disclosure.

### DETAILED DESCRIPTION

The present disclosure relates to isoporous polymer membranes comprising a polymeric film having a plurality of isopores. The isoporous polymer membranes can have one or more of the following characteristics: a porosity of at least 20%, such as a porosity of about 20% or greater; a plurality of isopores arranged in a periodically ordered array, wherein the plurality of isopores extend through the entire membrane from a first membrane surface to a second membrane surface along an axis oriented perpendicular to the first and second membrane surfaces; a membrane size of about 45 cm² or greater, and a pore size of about 2 μm or less. The high porosity and uniform pore sizes of the isoporous polymer membranes of the present disclosure make them ideal for separation applications and biological applications. For example, the isoporous polymer membranes can be used to separate one or more biological components. In addition, the isoporous polymer membranes can be used as supports in lab-on-a-chip techniques. Advantageously, the isoporous polymer membranes are easily fabricated in solvent-free processes and thus do not require the harsh solvents and harsh reaction conditions required in conventional processes.

### Definitions

The terms recited below have been defined as described below. All other terms and phrases in this disclosure shall be construed according to their ordinary meaning as understood by one of skill in the art.

As used herein, the term “free-standing membrane” generally refers to a membrane having sufficient mechanical strength and/or mechanical stability such that the membrane does not require a support to maintain its structural integrity (e.g., shape, surface flatness, etc.). For example, a free-standing membrane is mechanically stable in the absence of a support or support layer. The free-standing membranes can be provided in any form or structural configuration, including, but not limited to, films, thin films, layers, coatings, etc. In addition, or in the alternative, the term “free-standing membrane” can also refer to membranes having no sublayer or formed in the absence of or without any sublayer, wherein the sublayer can be characterized as a porous sublayer, a non-ordered porous sublayer, and/or support layer, among other things. For example, some conventional asymmetric membranes can be formed by a combination of block copolymer self-assembly and phase inversion, wherein the fabrication process includes the formation of a thin film layer on top of a non-ordered porous support layer. Although not required, the polymer membranes can optionally be deposited on a substrate, which is not particularly limited as any substrate known in the art can be used.

As used herein, “porosity” generally refers to a measure of the void fraction in a material, such as a membrane.

As used herein, the term “isoporous membrane” refers to any membrane comprising or consisting of isopores. In some embodiments, the term “isoporous membrane” is used to describe membranes with a low variance in pore size distribution. In some embodiments, the term “isoporous membrane” is used to describe membranes with no variance or substantially no variance in pore size distribution. In some embodiments, the term “isoporous membrane” is used to describe membranes with a uniform pore size distribution. In some embodiments, the term “isoporous membrane” is used to describe membranes comprising or consisting of pores having the same or substantially the same pore size (e.g., pore diameter). In some embodiments, the term “isoporous membrane” is used to describe membranes comprising or consisting of pores characterized by a single pore size.

As used herein, the term “isopores” refers to the pores of an isoporous membrane. In some embodiments, the term “isopores” refers to the pores of a membrane with a low variance in pore size distribution. In some embodiments, the term “isopores” refers to the pores of a membrane with no variance or substantially no variance in pore size distribution. In some embodiments, the term “isopores” refers to the pores of a membrane with a uniform pore size distribution. In some embodiments, the term “isopores” refers to pores with the same or substantially the same pore size (e.g., pore diameter). In some embodiments, the term “isopores” refers to pores characterized by a single pore size.

As used herein, the term “inter-pore spacing” refers to the distance between two adjacent pores.

As used herein, the term “ordered array” of pores generally refers to a predetermined pattern or arrangement of pores, which can be random or non-random, symmetrical or non-symmetrical. For example, in some embodiments, any membrane having an arrangement of pores transferred from a photomask through a photolithography and/or etching process can be said to have an ordered array of pores. Photomasks generally have predetermined patterns and/or predetermined arrangements of pores because they are fabricated from a design that is transferred or imparted to the photomasks. As used herein, the term “periodically ordered array” of pores generally refers to an array having a periodic or repetitive spatial arrangement of pores, which can be symmetrical or non-symmetrical, or a symmetrical spatial arrangement of pores. An example of a plurality of isopores arranged in a periodically ordered array is a polymeric film having isopores distributed in rows and columns. Other configurations are possible and within the scope of the present disclosure.

As used herein, “pore size” refers to the distance between opposing walls of a pore. For example, in some embodiments, the pore size refers to a pore diameter for cylindrical or cylindrically-shaped pores. In some embodiments, the pore size refers to a pore width for slip-shaped pores.

As used herein, the term “size of the membrane” generally refers to the area of the membrane. In some embodiments, the “size of the membrane” refers to the dimensional area of the membrane, as opposed to the surface area of the membrane, which would include the surface area of the pores. In other embodiments, the “size of the membrane” refers to the surface area of the membrane.

### Isoporous Polymer Membranes

Some embodiments of the present disclosure describe isoporous polymer membranes comprising or consisting of a polymeric film having a plurality of isopores arranged in an ordered array or a periodically ordered array.

In some embodiments, the polymeric film is made of or includes one or more polymers. In some embodiments, the one or more polymers are selected from one or more classes of polymers. Examples of such classes of polymers include, but are not limited to, thermosetting polymers, UV-curable polymers, and combinations thereof. In some embodiments, the one or more polymers are selected from polyvinylidene fluoride, polyacrylonitrile, polyethylene, polypropylene, polycarbonate, polysulfone, polyethersulfone, polystyrene, polytetrafluoroethylene, epoxies, cellulose, poly-triazole, poly-oxadiazole, polyether ether ketone, cross-linker polymers, acrylic polymers, polyurethanes, polyesters, and combinations thereof.

In some embodiments, the porosity of the polymeric film is 20% or greater. In some embodiments, the porosity of the polymeric film is about 20%. In some embodiments, the porosity of the polymeric film is about 20% to about 50%. In other embodiments, the porosity of the polymeric film is at least about 20%. In some embodiments, the porosity of the polymeric film is about 25% to about 50%. In other embodiments, the porosity of the polymeric film is at least about 25%. In some embodiments, the porosity of the polymeric film is about 40% to about 50%. In other embodiments, the porosity of the polymeric film is at least about 40%. In some embodiments, the porosity of the polymeric film is about 35% to about 50%. In other embodiments, the porosity of the polymeric film is at least about 35%. In some embodiments, the porosity of the polymeric film is about 30% to about 50%. In other embodiments, the porosity of the polymeric film is at least about 30%. In some embodiments, the porosity of the polymeric film ranges from about 0.01% to about 80%, or any increment thereof.

In some embodiments, the membranes comprise a high number of isopores to achieve the highly isoporous polymer membranes of the present disclosure. The number of pores present on the membranes of the present disclosure can depend on, for example, the membrane size and the polymer from which the membrane is fabricated. In some embodiments, the membranes comprise between about 1 pore to about 900 million pores, or any increment thereof. In some embodiments, the membrane has about 500 million pores. In some embodiments, the membrane has about 250 million pores. In some embodiments, the membrane has at least about 250 million pores. In some embodiments, the membrane has about 250 million pores or less. In some embodiments, the membrane has about 200 million pores. In some embodiments, the membrane has about 150 million pores. In some embodiments, the membrane has about 100 million pores. In some embodiments, the membrane has about 50 million pores. In some embodiments, the membrane has about 1 million pores. In some embodiments, the membrane has about 500,000 pores. In some embodiments, the membrane has about 100,000 pores. In some embodiments, the membrane has about 10,000 pores.

In some embodiments, the plurality of isopores is arranged in an ordered array. In some embodiments, the ordered array can span an entire surface of the membrane, or a portion of a surface of the membrane. For example, in some embodiments, the plurality of isopores is arranged in an ordered array that spans an entire surface of the membrane. In some embodiments, the plurality of isopores is arranged in an ordered array that spans a portion of the surface of the membrane. In embodiments in which the plurality of isopores is arranged in an ordered array that spans a portion of the surface of the membrane, the ordered array of isopores can be understood to span a region or section of the membrane surface that is less than the entire membrane surface. In some embodiments, the ordered array can span two entire surfaces of the membrane, or portions of two surfaces of the membrane. For example, in some embodiments, the plurality of isopores is arranged in an ordered array that spans two entire surfaces of the membrane. In some embodiments, the plurality of isopores is arranged in an ordered array that spans a portion of two surfaces of the membrane. In embodiments in which the ordered array of isopores spans two surfaces of the membrane, the ordered array of isopores can be understood to extend from a first membrane surface to a second membrane surface (e.g., the pores extend through the entire membrane).

In some embodiments, the plurality of isopores is arranged in a periodically ordered array. In some embodiments, the periodically ordered array can span an entire surface of the membrane, or a portion of a surface of the membrane. For example, in some embodiments, the plurality of isopores is arranged in a periodically ordered array that spans an entire surface of the membrane. In some embodiments, the plurality of isopores is arranged in a periodically ordered array that spans a portion of the surface of the membrane. In embodiments in which the plurality of isopores is arranged in a periodically ordered array that spans a portion of the surface of the membrane, the periodically ordered array of isopores can be understood to span a region or section of the membrane surface that is less than the entire membrane surface. In some embodiments, the periodically ordered array can span two entire surfaces of the membrane, or portions of two surfaces of the membrane. For example, in some embodiments, the plurality of isopores is arranged in a periodically ordered array that spans two entire surfaces of the membrane. In some embodiments, the plurality of isopores is arranged in a periodically ordered array that spans a portion of two surfaces of the membrane. In embodiments in which the periodically ordered array of isopores spans two surfaces of the membrane, the periodically ordered array of isopores can be understood to extend from a first membrane surface to a second membrane surface (e.g., the pores extend through the entire membrane).

In some embodiments, the arrays of isopores can be characterized by an inter-pore spacing. For example, in some embodiments, the arrays of isopores have a uniform inter-pore spacing. In these embodiments, the entire array of isopores can be understood as having the same inter-pore spacing. In some embodiments, the arrays of isopores have a substantially uniform inter-pore spacing. In these embodiments, the array of isopores can be understood as having substantially the same inter-pore spacing. In other embodiments, the arrays of isopores have a variable inter-pore spacing or non-uniform inter-pore spacing. In these embodiments, the array of isopores can be understood as having one or more distances defining the inter-pore spacing. The inter-pore spacing can range from, for example, about 0.7 μm to about 100 μm, or any increment thereof. In some embodiments, the inter-pore spacing ranges from about 2 μm to about 50 μm. In some embodiments, the inter-pore spacing is about 2 μm. In some embodiments, the inter-pore spacing is about 5 μm. In some embodiments, the inter-pore spacing is about 10 μm. In some embodiments, the inter-pore spacing is about 15 μm. In some embodiments, the inter-pore spacing is about 20 μm. In some embodiments, the inter-pore spacing is about 25 μm. In some embodiments, the inter-pore spacing is about 30 μm. In some embodiments, the inter-pore spacing is about 35 μm. In some embodiments, the inter-pore spacing is about 40 μm. In some embodiments, the inter-pore spacing is about 45 μm. In some embodiments, the inter-pore spacing is about 50 μm.

In some embodiments, the plurality of isopores extend completely or partially through or into the membrane along an axis perpendicular to a surface of the membrane. The degree or extent to which the pores extend through the membrane is not particularly limited. For example, in some embodiments, the plurality of isopores extend through the membrane from a first membrane surface to a second membrane surface. In some embodiments, the plurality of isopores extend through the membrane from a first membrane surface to a second membrane surface along an axis perpendicular to the first and second membrane surfaces. In some of these embodiments, the plurality of isopores can be understood to form through-pores in which the plurality of isopores extend completely through the membrane and form a continuous pathway from one surface or side of the membrane to another surface or side of the membrane. In some of these embodiments, the arrangement of the plurality of isopores on the first membrane surface is the same as the arrangement of the plurality of isopores on the second membrane surface. In other embodiments, the plurality of isopores extend from a surface of the membrane to a point within the membrane. In other embodiments, the plurality of isopores extend from a surface of the membrane to a point within the membrane along an axis perpendicular to the membrane surface. In any of these embodiments, the plurality of isopores can be understood to extend partially through the membrane and form, for example, cavities or holes.

In some embodiments, the pore size of the plurality of isopores is constant along the entire length of the axis running perpendicular to the surface of the membrane. For example, in some embodiments, the membrane comprises cylindrically-shaped or cylindrical pores. In these embodiments, the pore diameter of the plurality of isopores is constant along the entire length of the axis running perpendicular to the surface of the membrane. In some of these embodiments, the cross-sectional areas of the isopores can be understood to be constant. In other embodiments, the pore size of the plurality of isopores is variable along the length of the axis running perpendicular to the surface of the membrane. For example, in some embodiments, the membrane comprises cone-shaped pores. In these embodiments, the pore diameter of the plurality of isopores can decrease, or increase, along a length of the axis running perpendicular to the surface of the membrane. In some of these embodiments, the cross-sectional areas of the isopores can be understood to be variable.

In some embodiments, the pores can be characterized as encompassing a pore shape. The pore shape is not particularly limited. For example, in some embodiments, the pores have a cylindrical shape. In some embodiments, the pores having an elliptical shape. In some embodiment, the pores having a slit shape. In some embodiments, the pores having a spherical shape. In some embodiments, the pores have a square shape.

In some embodiments, the isopores have a pore size selected from any size within the range of about 0.7 μm to about 100 μm. In some embodiments, the isopores have a pore size of about 0.7 μm. In some embodiments, the isopores have a pore size of about 1 nm. In some embodiments, the isopores have a pore size of about 5 μm. In some embodiments, the isopores have a pore size of about 10 μm. In some embodiments, the isopores have a pore size of about 20 μm. In some embodiments, the isopores have a pore size of about 30 μm. In some embodiments, the isopores have a pore size of about 40 μm. In some embodiments, the isopores have a pore size of about 50 μm. In some embodiments, the isopores have a pore size of about 100 μm. In some embodiments, the isopores have a pore size of about 250 μm. In some embodiments, the isopores have a pore size of about 500 μm. In some embodiments, the isopores have a pore size of about 2 μm or less. In some embodiments, the isopores have a pore size of about 3 μm. In some embodiments, the isopores have a pore size of about 4 μm. In some embodiments, the isopores have a pore size of about 5 μm. In some embodiments, the isopores have a pore size of about 6 μm. In some embodiments, the isopores have a pore size of about 7 μm. In some embodiments, the isopores have a pore size of about 8 μm. In some embodiments, the isopores have a pore size of about 9 μm. In some embodiments, the isopores have a pore size of about 10 μm. In some embodiments, the isopores have a pore size of about 50 μm. In some embodiments, the isopores have a pore size of about 100 μm. In some embodiments, the plurality of isopores are characterized as a plurality of micro-isopores. In some embodiments, the plurality of isopores are characterized as a plurality of nano-isopores.

In some embodiments, the size of the membrane can range from about 45 cm² to about 1 m². For example, in some embodiments, the size of the membrane is about 40 cm², or greater. In some embodiments, the size of the membrane is about 39 cm², or greater. In some embodiments, the size of the membrane is about 38 cm², or greater. In some embodiments, the size of the membrane is about 37 cm², or greater. In some embodiments, the size of the membrane is about 36 cm², or greater. In some embodiments, the size is greater than about 36 cm², or greater. In some embodiments, the size of the membrane is about 35 cm², or greater. In some embodiments, the size of the membrane is about 30 cm², or greater. In some embodiments, the size of the membrane is about 25 cm², or greater. In some embodiments, the size of the membrane is about 20 cm², or greater. In some embodiments, the size of the membrane is about 15 cm², or greater. In some embodiments, the size of the membrane is about 10 cm², or greater. In some embodiments, the size of the membrane is about 5 cm², or greater. In some embodiments, the size of the membrane is about 1 cm², or greater.

In some embodiments, a thickness of the membrane ranges from about 2 μm to about 5 cm. In some embodiments, a thickness of the membrane is about 1 μm. In some embodiments, a thickness of the membrane is about 2 μm. In some embodiments, a thickness of the membrane is about 2 μm. In some embodiments, a thickness of the membrane is about 2.5 μm. In some embodiments, a thickness of the membrane is about 5 μm. In some embodiments, a thickness of the membrane is about 100 μm. In some embodiments, a thickness of the membrane is about 1 cm.

In some embodiments, the membrane is a free-standing membrane. In some embodiments, the membrane is a membrane is deposited on a substrate. In some embodiments, the membrane is characterized in that it is a membrane formed without any porous layer.

In some embodiments, the membranes further optionally comprise a polymer layer comprising one or more polymers polymerized or deposited on one or more surfaces. In some embodiments, the membranes further optionally comprise a polymer layer comprising one or more polymers polymerized or deposited on a surface of the plurality of isopores (e.g., the interior surfaces of the membrane forming the plurality of isopores). In some embodiments, the membranes further comprise a polymer layer comprising one or more polymers polymerized or deposited on a surface of the membrane. In some embodiments, the membranes further comprise a polymer layer comprising one or more polymers polymerized or deposited on a surface of the plurality of isopores and a surface of the membrane. In some embodiments, the membranes further comprise said polymer layers to further reduce the pore size of the plurality of isopores (e.g., micro isopores to nano isopores). While a layer of a polymer can be deposited or polymerized on a surface of the membrane, it is important to note that it is not required to do so in order to achieve membranes with nano-sized isopores. For example, in some embodiments, the polymerization of a polymer on the isopore surfaces is another technique or option available for tuning the pore size of the pores of the membrane.

In some embodiments, the polymer layer has a uniform thickness. In some embodiments, the polymer layer has a substantially uniform thickness. In some embodiments, the polymer layer has a non-uniform or variable thickness.

In some embodiments, the polymer layer reduces the pore size. In some embodiments, the polymer layer reduces the pore size by about 0.01% to about 100%. For example, in some embodiments, the polymer layer reduces the pore size by about 1%. In some embodiments, the polymer layer educes the pore size by about 5%. In some embodiments, the polymer layer educes the pore size by about 25%. In some embodiments, the polymer layer educes the pore size by about 45%. In some embodiments, the polymer layer educes the pore size by about 50%. In some embodiments, the polymer layer educes the pore size by about 60%. In some embodiments, the polymer layer educes the pore size by about 75%. In some embodiments, the polymer layer educes the pore size by about 80%.

In some embodiments, the one or more polymers of the polymer layer are polymerized or deposited on the membrane and/or isopores by parylene deposition or polymerization. Parylene is generally a generic name for thermoplastic polymers based on para-xylylene. Examples of suitable parylene polymers include, but are not limited to, di(p-xylylene) or parylene N, di(monochloro-p-xylylene) or parylene C, and di(chloro-p-xylylene) or parylene D, among others. The paralene polymers used are not particularly limited and can include any suitable polymers known in the art. x Examples of suitable parylene polymers include, but are not limited to, di(p-xylylene) or parylene N, di(monochloro-p-xylylene) or parylene C, and di(chloro-p-xylylene) or parylene D, among others.

In some embodiments, the one or more polymers of the polymer layer are polymerized or deposited on the membrane and/or isopores by graft polymerization. The polymers used are not particularly limited and can include any suitable polymers known in the art. Examples of monomers or polymers suitable for graft polymerization include, but are not limited to, polyolefins, vinylics, styrenics, acrylonitrilics, acrylics, cellulosics, polyamides, thermoplastic polyesters, thermoplastic polycarbonates, polysulfones, polyimides, polyether/oxides, polyketones, fluoropolymers, copolymers thereof, or mixtures thereof.

In some embodiments, the one or more polymers of the polymer layer are polymerized or deposited on the membrane and/or isopores atom transfer radical polymerization. The polymers used are not particularly limited and can include any suitable polymers known in the art. Examples of monomers or polymers suitable for atom transfer radical polymerization include, but are not limited to, one or more of styrenes, acrylates, methacrylates, acrylamides, acrylonitriles, isobutylene, dienes, vinyl acetate, N-cyclohexyl maleimide, 2-hydroxyethyl acrylates, 2-hydroxyethyl methacrylates, and fluoro-containing vinyl monomers, among others.

In other embodiments, any technique known in the art can be used to reduce or tune pore sizes of the membranes, without departing from the scope of the present disclosure.

In some embodiments, the isoporous polymer membranes comprise or consist of one or more isopore groups, wherein the isopores of each isopore group are characterized a single pore size. For example, in some embodiments, the isoporous polymer membrane comprises or consists of a first isopore group and a second isopore group, wherein the first isopore group comprises or consists of pores having a single first pore size and the second isopore group comprises or consists of pores having a single second pore size, wherein the single first pore size and the single second pore size are different. In some embodiments, the isoporous polymer membrane can comprise or consist of one or more isopore groups, wherein the isopores of each isopore group have the same or substantially the same pore size. For example, in some embodiments, the isoporous polymer membrane comprises or consists of a first isopore group and a second isopore group, wherein the first isopore group comprises or consists of pores having the same or substantially the same first pore size and the second isopore group comprises or consists of pores having the same or substantially the same second pore size, wherein the first pore size and the second pore size are different.

### Methods of Fabricating Isoporous Polymer Membranes

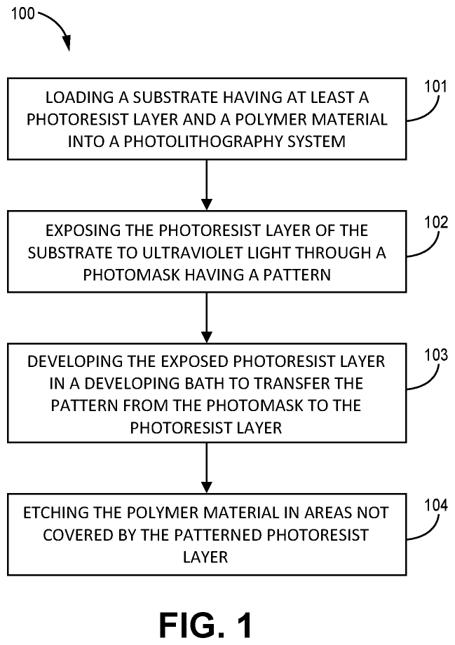

FIG. 1 is a flowchart of a method of fabricating an isoporous polymer membrane, according to one or more embodiments of the present disclosure. As shown in FIG. 1, the method 100 can comprise loading 101 a substrate having at least a photoresist layer and a polymer layer into a photolithography system, exposing 102 the photoresist layer of the substrate to ultraviolet through a photomask having a pattern, developing 103 the exposed photoresist layer in a developing bath to transfer the pattern from the photomask to the photoresist layer, and etching 104 the polymer material in areas not covered by the patterned photoresist layer to form an isoporous polymer membrane having high porosity and a periodically ordered array of isopores. At least one advantage of the method 100 is that it is a solvent-free method of forming isoporous polymer membranes.

The step 101 includes loading a substrate having at least a photoresist layer and a polymer material into a photolithography system. In some embodiments, the loading is sufficient to secure or mount the substrate, photoresist layer, and polymer material in the photolithography system. The substrate, photoresist layer, and photolithography system are not particularly limited. In some embodiments, the substrate is a silicon wafer. In some embodiments, any substrates known in the art for photolithography can be used herein without departing from the scope of the present disclosure. In addition, the photoresist layer can be selected form any suitable photoresist. For example, in some embodiments, the photoresist layer is selected from AZ-9260 photoresist, AZ-5214 photoresist, and combinations thereof. The photolithography system can include any photolithography device or apparatus known in the art.

In some embodiments, the polymer material can include or be prepared from one or more polymers. In some embodiments, the polymer can be selected from polyvinylidene fluoride, polyacrylonitrile, polyethylene, polypropylene, polycarbonate, polysulfone, polyethersulfone, polystyrene, polytetrafluoroethylene, epoxies, cellulose, poly-triazole, poly-oxadiazole, polyether ether ketone, cross-linker polymers, acrylic polymers, polyurethanes, polyesters, and combinations thereof. In some embodiments, the polymer material is provided in the form of a polymer film. In other embodiments, the polymer material is provided in other forms, such as a polymer coating or polymer layer, among other types. In some embodiments, the polymer material is selected to have characteristics and/or properties suitable for photolithography, etching, and/or a desired end use or application. For example, in some embodiments, the selection of the polymer is based on any of a variety of considerations, including, but not limited to, the mechanical properties, structural properties, surface properties, chemical properties, and thermal properties of the polymer or combination of polymers, and/or membrane. In some embodiments, the polymer or combination of polymers is/are selected to afford flexible polymer membranes, with smooth surfaces, and that exhibit high tolerance to heat and abrasion, as well as chemical resistance in the presence of harsh reagents, solvents, and other chemical species.

In some embodiments, the polymer material is a polymer film. In some embodiments, the polymer film can have an adhesive film provided on at least one surface of the polymer film. For example, in some embodiments, the adhesive film can comprise a film layer coated with an adhesive layer, such as an acrylic adhesive layer. The adhesive film is optional and can function as a support such that the polymer film is provided as a flat and fixed surface on a silicon wafer to aid in providing a uniform coating of the photoresist layer. In some embodiments, the adhesive film is an ultraviolet light-sensitive adhesive layer. In an embodiment, a silicon wafer can have a photoresist layer deposited thereon. For example, a micron-thick photoresist layer (e.g., about 1.6 μm layer) can be spin-coated onto the silicon wafer as an additional adhesive material. The photoresist layer that is deposited on the silicon wafer can be brought into contact with the adhesive film provided on the polymer film. In an embodiment, the polymer film-adhesive film composite can be rolled onto the silicon wafer-photoresist layer composite such that air does not get trapped therebetween. The entire silicon wafer with one or more of the layers can then be baked in an oven for a select period of time at a suitable temperature. For example, the entire silicon wafer with one or more of the layers/films can be baked in an oven for about 30-60 seconds at about 110° C. A skilled person will recognize that other durations and temperatures, and modifications to the selection of the layers deposited on the silicon wafer, can be employed herein without departing from the scope of the present disclosure.

The step 102 includes exposing the photoresist layer of the substrate to ultraviolet light through a photomask having a pattern. The exposing is typically sufficient to chemically alter or modify the photoresist such that either the photoresist becomes soluble in a developer (e.g., as in positive photoresist) or the regions not exposed become soluble in a developer (e.g., as in negative photoresist). The exposure duration is not particularly limited and should be sufficient to achieve the objectives of the methods described herein. In addition, the present methods expose the photoresist layer to ultraviolet light, but other wavelengths of light can be used, depending on the photoresist layer and the photolithography system being used, among other things. Accordingly, the use of ultraviolet light shall not be limiting. In an embodiment, the exposing include exposing to ultraviolet light under 80 mJ/cm² in vacuum and hard contact mode. A skilled person will recognize that other conditions and parameters are suitable for and thus can be used for the methods described herein.

The photomask can have any of a variety of patterns to be imparted to the polymer membrane. At least one advantage of the present disclosure is that the patterns are highly customizable and thus can be tailored for any application or intended use of the polymer membranes. For example, the patterns can be used to tailor the pore size, pore size distribution, porosity, pore depth, surface area, inter-pore spacing, pore shape, total number of pores, cross-sectional area of the pore, the spatial distribution and/or arrangement of the pores, and pore shape, among other parameters. Accordingly, the pattern is not particularly limited. For example, in an embodiment, the pattern comprises symmetrical 2 μm cylindrical pores with identical 2 μm pore-to-pore spacing, wherein the pores are arranged in rows and columns to form a grid.

In an embodiment, the photomask can be fabricated by designing a pattern using software, such as Tanner EDA L-Edit software, and printed. The photomask can then be exposed and subsequently developed in any suitable developer, such as AZ-726 MIF Developer, for any duration suitable to precisely dissolve the photoresist in exposed areas. The photomask can be washed with water (e.g., a water spray) to remove excess developer from the photomask for a select duration, such as about 30 seconds. The photomask can be placed in an etchant bath, such as a chromium etchant bath, at about room temperature and the etchant bath can be agitated for a select duration, such as about 90 seconds. The photomask can be washed for a second time with water and dried by blowing nitrogen. The photomask can then be placed in a UV-LED system to fix the pattern on the photomask for about 30 min.

The step 103 includes developing the exposed photoresist layer in a developing bath to transfer the pattern from the photomask to the photoresist layer. In this step, the developing can depend on the photoresist. For example, positive photoresist becomes soluble and is removed during the developing, whereas with negative photoresist, unexposed regions become soluble during the developing. The developing can proceed by immersing in a developing bath and optionally subsequently washing and drying, either of which can be performed one or more times. The developing bath can include any suitable developer, such as AZ-726 MIF Developer, and thus is not particularly limited. The duration of the developing can range from about 1 sec to about 30 min, although typically, the duration of the developing is about 90 seconds. The washing can include washing with water and the drying can include drying by blowing nitrogen over the exposed photoresist layer.

The step 104 includes etching the polymer material in areas not covered by the patterned photoresist layer to form an isoporous polymer membrane having high porosity and a periodically ordered array of isopores. In this step, the pores can be formed in the polymer material. The etching can include inductive-coupling plasma reactive ion etching. For example, in an embodiment, the etching includes inductive-coupling plasma reactive ion etching with the following parameters: flowing sulfur hexafluoride (SF₆) at 10 standard cubic centimeters per minute and oxygen at 30 standard cubic centimeters per minute, pressure of about 10 mT, RF power at about 50 W, ICP power at about 800 W, for a total of about 15 minutes, wherein the 15 minutes includes about 3 cycles of 4 minute etching and 3 rest breaks of about 1 min. In an embodiment, the etching further comprises washing with one or more of acetone, isopropyl alcohol, and water, and/or drying by blowing nitrogen.

In some embodiments, the method further comprises washing the isoporous polymer membrane with acetone and curing the isoporous polymer membrane to release the ultraviolet light-sensitive adhesive layer.

### Applications of Isoporous Polymer Membranes

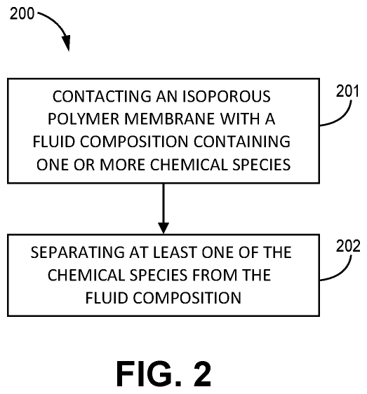

FIG. 2 is a flowchart of a method of separating one or more chemical species, according to one or more embodiments of the present disclosure. As shown in FIG. 2, the method can comprise contacting 201 any of the isoporous polymer membranes of the present disclosure with a fluid composition containing one or more chemical species, and separating 202 at least one of the chemical species from the fluid composition. The contacting 201 can include bringing the isoporous polymer membranes of the present disclosure and fluid composition into physical contact, or close or immediate proximity. The separating 202 can proceed by sorbing (e.g., adsorbing, absorbing, desorbing, or combinations thereof) or sieving (e.g., as in molecular sieve), among other methods of separating. In some embodiments, the separating 202 includes one or more of isolating, purifying, concentrating, filtering, and removing. The fluid compositions are not particularly limited. For example, in some embodiments, the fluid compositions comprise one or more biological components.

TABLE 1
Previously reported microporous membranes fabricated with lithography assistance

| | | | Space | | | |
|---|---|---|---|---|---|---|
| | | Pore | between | | | |
| | | Diameter | pores | Max Area | Porosity | |
| Authors | Material | (μm) | (μm) | (cm2) | (%) | Methodology |

inorganic membranes

| Ogura et al., | Silicon | 1-1.8 | μm | N/A | N/A | | N/A | Si₃N₄ deposition, electron |
|---|---|---|---|---|---|---|---|---|
| 1991 | Nitride membrane | | | | | | | beam lithography, plasma |
| | | | | | | | | etching |
| Desai et al., | Silicon membrane | 18 nm, | | N/A | 0.104 | cm² | N/A | deposition, photolithography, |
| 1999 | | 78 nm, | | | | | | plasma and anisotropic |
| | | 3 μm | | | | | | etching |
| Vaeth, 2012 | Silicon membrane | 3-5 | μm | 40 μm | 1.62 | cm² | 9% | deposition, hard mask |
| | | | | between | | | | lithography, fluid channel |
| | | | | clusters | | | | lithography, etching |
| Warkiani et | Metallic | 2.5 × 8 μm | | N/A | 78.5 | cm² | N/A | multilevel UV-lithography, |
| al., 2012 | membrane | rectangular pores | | | | | | electroplating |
| Carter et al., | Glass (SiO₂) | 3 μm and 0.5 μm | | N/A | 14 | cm² | 20% | SiO₂ deposition, |
| 2017 | membrane | | | | | | | photolithography, RI etching |
| Salminen et | Silicon Nitride | 3 | μm | N/A | 0.7 × 2 | mm | 9-30% | lithographic laser writer |
| al., 2019 | membrane | | | | | | | system, RI etching |

organic membranes

| Brauker et | Polyimide | 20 | μm | 2-5 | μm | 1 | cm² | N/A | polyimide nonporous film |
|---|---|---|---|---|---|---|---|---|---|
| al., 1998 | membrane | | | | | | | | formation, lithography, |
| | | | | | | | | | oxygen curing |
| Zheng et al., | Single layered | 10 | μm | 10 | μm | 0.36 | cm² | 5.6% | parylene deposition, |
| 2007 | Parylene | | | | | | | | photolithography-based |
| | membrane | | | | | | | | patterning and direct etching |
| Huh et al., | PDMS | 10 | μm | 30 | μm | 2 | cm² | N/A | soft lithography, wet etching |
| 2010 | poly(dimethylsiloxane) | | | | | | | | |
| | membrane | | | | | | | | |
| Hosokawa et | PET membrane | 4-2 | μm | 60 | μm | 4 | cm² | 0.01% | photolithography-based |
| al., 2010 | | | | | | | | | electroforming |
| Xu et al., | Parylene film | 6 | μm | N/A | | 0.36 | cm² | 18% | parylene deposition, |
| 2010 | | | | | | | | | photolithography, wet |
| | | | | | | | | | etching |
| Warkiani et | SU-8 (Bisphenol | 3 × 12 | μm | 4 μm & 2 μm | | 600 × 600 | μm² | 40% | nonporous film formation, |
| al., 2011 | A Novolac epoxy) | | | | | | | | twice repeated |
| | film | | | | | | | | photolithography |
| Harouaka et | Parylene | 4-7 | μm | N/A | | 0.5 | cm² | N/A | parylene deposition, |
| al., 2014 | microspring | | | | | | | | photolithography, RI etching |
| | structures | | | | | | | | |
| Kim et al., | Parylene HT | 0.8-4 | μm | N/A | | 0.65 × 0.65 | cm² | 5-40% | parylene deposition, Ti |
| 2014 | membrane & | | | | | | | | deposition, photolithography, |
| | 1002F (epoxy | | | | | | | | dry etching |
| | resin) membrane | | | | | | | | |
| Tang et al., | PEGDA | 5.5-8 | μm | 22-24 | μm | 0.81 | cm² | 3-6% | photolithography, molding |
| 2014 | (Polyethylene | | | | | | | | |
| | glycol diacrylate) | | | | | | | | |
| | filters | | | | | | | | |
| Zhou et al., | Double layered | 8 | μm | 12 | μm | 1 | cm² | 7% | parylene deposition, |
| 2014 | Parylene | | | | | | | | photolithography, aluminium |
| | membrane | | | | | | | | etching |
| Adams et | SU-8 (Bisphenol | 5-9 | μm | 20 | μm | <0.64 | cm² | 12.5% | nonporous film formation, |
| al., 2016 | A Novolac epoxy) | | | | | | | | photolithography |
| | film | | | | | | | | |
| Musah et al., | PDMS | 7 | μm | 30 | μm | N/A | | N/A | soft lithography, wet etching |
| 2017 | poly(dimethylsiloxane) | | | | | | | | |
| | membrane | | | | | | | | |
| This work | Polyester | 0.5-50 | μm | 2-50 | μm | 45 | cm² | 50% | photolithography, dry RI |
| | membrane | | | | | | | | etching |

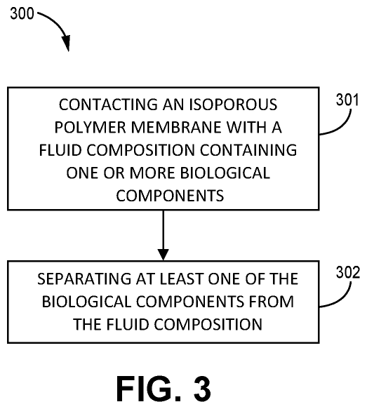

FIG. 3 is a flowchart of a method of separating one or more biological components, according to one or more embodiments of the present disclosure. As shown in FIG. 3, the method 300 can comprise contacting 301 a fluid composition including one or more biological components with a membrane according to any one of the claims herein and separating 302 at least one of the biological components from the fluid composition. In some embodiments, the biological components include cells, organelles, and/or biomolecules. The contacting 301 and separating 302 can include and/or proceed as described above. For example, in some embodiments, the separating includes one or more of isolating, purifying, concentrating, filtering, and removing.

Some embodiments of the present disclosure describe a device comprising a first compartment and a second compartment separated by a membrane according to any one of the claims herein. In some embodiments, the membrane functions as an extracellular matrix. Some embodiments of the present disclosure also describe methods comprising providing any of the isoporous polymer membranes of the present disclosure for use in an organ-on-a-chip technique.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

### Isoporus Polymer Membranes

This Example presents a new fabrication methodology through which highly micro-isoporous membranes with 50% of porosity can be obtained.

### Materials and Methods

Methodology: (step1) Photolithography technique, (step2) Dry reactive ion etching process. Equipment: μPG501 direct-writing tool, EVG-620 Nano-imprint lithography tool, inductive-coupled plasma reactive ion etching (ICP-RIE) equipment. Materials: Polyester Film, photomask, silicon wafer, adhesive tape, photoresists, chromium etchant, developer, acetone.

Micro pores were fabricated in nonporous Polyester film (Mylar) purchased commercially. The main purpose of choosing the Mylar film was to provide high properties to the final product, making it tunable and adaptable for various applications. Polyester film exhibits excellent resistance to the action of many chemical reagents, solvents and impregnants. It has high heat (150° C. operation temperature) and abrasion tolerance, it has smooth and flexible surface, and, it is easily washed and dried. In other words, the film is mechanically sustainable for complex and harsh experimental conditions. The film was chosen with about 2.5 μm thickness and with surface size of about 2.5 inches (about 63.5 mm) in diameter.

### Photomask Fabrication

The pattern filled with symmetrical 2 μm cylindrical pores with identical 2 inn pore-to-pore space was designed using Tanner EDA L-Edit software. The porous region area was equal to the size of Polyester film, hence it contained around 250 million of pores. The μPG501 direct-writing tool (Heidelberg Instruments) had been printing the pattern during 3 hours, excluding 3 hours' time of pattern file format conversion to the tool's system. After exposure, the photomask was developed in AZ-726 MIF Developer for 60 seconds precisely to dissolve photoresist on exposed area. Then, we washed off the developer thoroughly with deionized (DI) water spray for 30 seconds. After washing, the photomask was placed in chromium etchant bath (Cr01 UN 3264, TechniEtch) at room temperature and the bath was agitated gently for 90 seconds. The photomask was then washed again with DI water and dried blowing nitrogen. At the last step, to fix the pattern, the photomask was placed in UV-LED system (UV-KUB 2 tool, KLOE) for 3 minutes.

### Sample Preparation

The polyester film was attached firstly to a special tape-film coated with acrylic adhesive layer (Load Point, micro-machining solutions) which was functioning as a support to have a flat and fixed film surface on top of silicon wafer aiding for uniform photoresist coating. The tape was UV-sensitive, which provided an easy way of detaching after the pores fabrication processes.

### Microporous Membrane Fabrication

First, on top of a silicon wafer, AZ-9260 photoresist was applied by spin-coating which was acting, at this place, as a glue between tape-polyester film and wafer. Here, the tape-polyester film was rolled accurately on top of it avoiding air bubbles formation. The film laminated wafer was then spin-coated with a thin 1.6 μm layer of AZ-5214 photoresist. Next, the wafer was baked for about 30 seconds at about 110° C. The film-layered wafer was exposed under the patterned photomask by Photolithography process of EVG-620 tool. The UV light exposure run under about 80 mJ/cm² dose and vacuum+hard contact mode. After exposure, the wafer was immersed in a developing bath (AZ-726 MIF Developer) for about 90 seconds, rinsed in DI water for about 1 minute and dried by blowing nitrogen. The pores fabrication was finalized with a dry etching process using an inductive-coupled plasma reactive ion etching (ICP-RIE) equipment (from Oxford Instruments) with the following parameters: gases used were sulfur hexafluoride (SF₆) at about 10 standard cubic centimeters per minute (sccm) and oxygen (O₂) at about 30 sccm, pressure of about 10 mT, RF power at 50 W, ICP power at 800 W, for about 15 minutes=3 steps of about 4 minutes etching and 3 rest breaks for about 1 minute each. Next, the film-layered wafer was washed with acetone for about 1 minute, then rinsed with isopropyl alcohol and DI water. After dehydration by blowing nitrogen the wafer was cured with UV using UV curing system U-200 (POWATEC) to release attached tape from the membrane.

For microfabrication processes, triple layered photoresist-chromium-glass Photomask (5-inch diameter from Nanofilm) and silicon wafer (4-inch diameter from University Wafer) was used.

### Results

Fabricated micro isoporous (all pores are identical and symmetrical) polyester membrane with about 50% porosity. The size of the fabricated membrane with full active microporous area was about 40 cm². Capability of the methodology: pores size, shape and pore-to-pore space are controlled fully. Pore size can be fabricated in any micrometers up to 2 μm (>2 μm) and porosity can reach 50%.

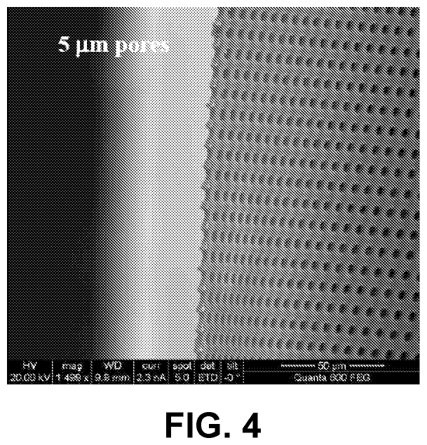

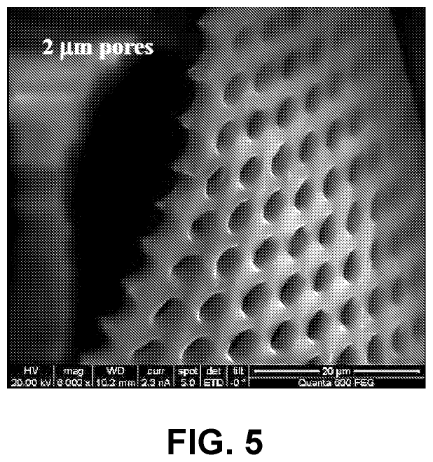

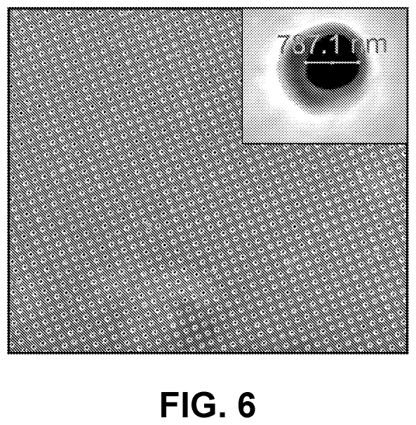

FIG. 4 is an image of a top surface of an isoporous polymer membrane with a pore size of 5 μm, according to one or more embodiments of the present disclosure. FIG. 5 is an image of a top surface of an isoporous polymer membrane with a pore size of about 2 μm, according to one or more embodiments of the present disclosure. FIG. 6 is an image of a top surface of an isoporous polymer membrane with a pore size of about 2 μm, wherein the isoporous polymer membrane has been transformed into an isoporous polymer membrane with a pore size of about 787 nm, according to one or more embodiments of the present disclosure.

### Example 2

### Plant Cells Fractionation (Separation)

The fundamental and the most important step for all processes in biochemistry, cellular and molecular biology as well as in medicine fields is separation of one group of particles from another. For instance, the isolation of cells, subcellular organelles and macromolecules such as DNA, RNA or proteins (of plant, animal and human) from their surrounding medium gives the valuable way of deep study and analyses of their nature and behavior; separation bacterial cells from the bulk (water, blood) provides purification effect. Current approach for separation processes rely on centrifugation which rotates the suspension in a high speed forcing particles to settle down due to a gravity by particles weight (density). The applied force is very huge (500 times greater than the Earth gravitational force) which breaks most macro particles. Centrifugation also does not give precise and pure separation, which is another disadvantage.

The fabrication method described herein provided precise control over the pore size and shape for the fabrication of membranes that target the specific size of separating particles enrich the separation rate. The separation process using the membranes of the present disclosure did not require high force which provided gentle separation avoiding any particles breakage.

### Example 3

### As a Membrane Matrix (Support) in Organ-on-a-Chip Technique

Pharmaceutical, cosmetology and food industries test their all new products before manufacturing in order to avoid any side effect in human body. Such experiments are implemented using animal models, creating many other damages: (1) cruelty on animals, (2) uncertainties to mimic human physiology by using animal models, (3) cost—around 2 billion USD per year, (4) time consuming. In order to cover these disadvantages a new advanced technique has been developed—organ-on-a-chip (OOC) which allows to test products using human cells. One of the important parts of the OOC set up is a flexible porous polymeric membrane which supports the cells (substrate for cell culture) and functions as an equivalent of the extracellular matrix, or more specifically, as the cell basement membrane found in natural tissue. It is applied for achieving cell adhesion and cell separation as well as cell communication between the two compartments. Currently, the track-etched membranes are used for such technique, which have several disadvantages (discussed above). The membranes of the present disclosure, which cover those disadvantages (mainly low porosity 10%), were able to improve significantly the OOC technique by increasing cells communication due to the high porosity of the membrane (50%).

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. An isoporous polymer membrane comprising: a polymeric film having a porosity greater than about 20% and a plurality of isopores arranged in a periodically ordered array, wherein the isopores have a uniform cylindrical pore shape extending from a first membrane surface to a second membrane surface along an axis perpendicular to the first and second membrane surfaces.

2. The membrane according to claim 1, wherein the polymer is selected from the group consisting of polyvinylidene fluoride, polyacrylonitrile, polyethylene, polypropylene, polycarbonate, polysulfone, polyethersulfone, polystyrene, polytetrafluoroethylene, epoxies, cellulose, poly-triazole, poly-oxadiazole, polyether ether ketone, cross-linker polymers, acrylic polymers, polyurethanes, polyesters, and combinations thereof.

3. The membrane according to claim 1, wherein the isoporous polymer membrane is a free-standing membrane without any porous sublayer.

4. The membrane according to claim 1, wherein the isoporous polymer membrane has an area of at least about 36 cm².

5. The membrane according to claim 1, wherein the isoporous polymer membrane has a porosity of about 30% or greater.

6. The membrane according to claim 1, wherein the isopores of the plurality are selected from nano-pores or micro-pores.

7. The membrane according to claim 1, wherein the isopores have a pore size within a range from about 0.7 μm to about 2 μm.

8. The membrane according to claim 1, where the isopores have a pore size within a range from about 2 μm to about 50 μm.

9. The membrane according to claim 1, wherein the periodically ordered array has uniform inter-pore spacing.

10. The membrane according to claim 1, wherein the plurality of isopores have a uniform pore size along the entire length of the axis perpendicular to the first and second surfaces of the membrane.

11-12. (canceled)

13. The membrane according to claim 1, further comprising a layer of polymer deposited substantially uniformly (a) on a surface of the membrane, (b) throughout each pore, or (c) on a surface of the membrane and throughout each pore.

14-16. (canceled)

17. A method of separating comprising:
contacting a medium including one or more biological components with an isoporous polymer membrane according to claim 1; and,
separating at least one of the biological components from the medium.

18. The method according to claim 17, wherein the biological components are selected from cells, organelles, biomolecules, and combinations thereof.

19. The method according to claim 17, wherein the separating includes isolating, purifying, concentrating, and/or filtering.

20. (canceled)

21. The membrane of claim 1, wherein the membrane has an area of about 45 cm² or greater, and optionally each isopore of the plurality has a pore size of about 2 μm or less.

22. The method of claim 17, wherein the membrane has an area of about 45 cm² or greater, each isopore of the plurality has a pore size of about 2 μm or less, or the membrane has an area of about 45 cm² or greater and each isopore of the plurality has a pore size of about 2 μm or less.

23. The method of claim 17, wherein the membrane further comprises a layer of polymer deposited substantially uniformly (a) on a surface of the membrane, (b) throughout each pore, or (c) on a surface of the membrane and throughout each pore.

24. A method of fabricating the membrane of claim 1, comprising:
loading a substrate having at least a photoresist layer and a polymeric film into a photolithography system;
exposing the photoresist layer of the substrate to ultraviolet light through a photomask having a pattern;
developing the exposed photoresist layer in a developing bath to transfer the pattern from the photomask to the photoresist layer; and
etching the polymeric film in areas not covered by the patterned photoresist layer to form an isoporous polymer membrane; whereby the membrane has a porosity greater than about 20%, a plurality of isopores arranged in a periodically ordered array, wherein the isopores have a uniform cylindrical pore shape extending from a first membrane surface to a second membrane surface along an axis perpendicular to the first and second membrane surfaces.

25. The method of claim 24, wherein etching includes inductive-coupling plasma reactive ion etching.

26. The method of claim 24, further comprising depositing a layer of polymer after etching.
